(19) United States
(12) Patent Application Publication
(10) Pub. No.: US 2011/0029478 A1
(43) Pub. Date: Feb. 3, 2011

(54) Stream Star Schema and Nested Binary Tree for Data Stream Analysis

(76) Inventor: Stephen A. BROEKER, Sunnyvale, CA (US)

Correspondence Address: SINORICA, LLC, 2275 Research Blvd., Suite 500, ROCKVILLE, MD, 20850, US

(21) Appl. No.: 12/772,799

(22) Filed: May 3, 2010

Related U.S. Application Data
(60) Provisional application No. 61/180,062, filed on May 20, 2009.

(51) Int. Cl. G06F 17/30

(52) U.S. Cl. 707/600; 707/E17.005

(57) ABSTRACT

An approach to processing data streams includes a new type dynamic database of stream star schema to accommodate high data stream rates for giga bits per second by reducing the insert time to a constant and a new type of data cube as nested binary tree to supports both data aggregates and data values.

The current application claims a priority to the U.S. Provisional Patent application Ser. No. 61/180,062 filed on May 20, 2009.

### FIELD OF INVENTION

This invention relates to Online analytical processing (OLAP) databases which are commonly implemented as multi-dimensional data cubes to handle SQL GROUP BY or aggregate queries and how to efficiently construct data cubes from streaming data.

### BACKGROUND OF THE INVENTION

Applying OLAP to streaming data is a relatively new challenge. First, data stream rates can be high. Data cube construction must keep up with the input stream. Second, data streams are often infinite with respect to time. Both of these problems greatly limit the time available for data cube construction. Current solutions sample the data stream. The resulting partial data cube is inadequate for complete data stream analysis.

In a streaming database, data streams come in at a high rate (gigabits per second) and the database is dynamic where data records are constantly added. Examples of such data streams are: computer network traffic, web site hits, credit card transactions, road traffic, video, power supplies, phone calls, and financial markets. To answer aggregate queries, such as how many network data records use a particular protocol and content, database records are organized as a multi-dimensional data cube, a structure where each cell corresponds to a unique combination of attribute values. Construction of such data cubes from a streaming database with a high incoming data rate is challenging. Consider a database where a record has l fields and field i has aᵢ different attributes. In the worst case, a data cube has

$${\prod }_{i = 1}^{l} ( {a}_{i} + 1 )$$

cells [1, 8]. Again, each cell corresponds to a unique combination of attributes of the l fields and contains the number of records that use that combination. The complete creation of the data cube is essentially impossible and unnecessary because the database is huge, streams come in at a very high rate, and some combinations of attributes may not be used by any records. In previous work, data cubes are constructed to only give an aggregate: the number of records that use a particular combination of attributes, not values: the list of records with those particular attributes.

### SUMMARY OF THE INVENTION

In this invention, a new structure: the stream star schema is proposed to handle high data stream rates by faster data record insertion into the database and to support faster construction of the data cube. Also, a new data cube type: the nested binary tree and its fast construction are proposed. This nested binary tree not only returns data aggregates but also data values that are missed by previous methods and therefore presents a complete detailed view of a data stream. The disclosed invention of the new structure of stream star schema and the new data cube type of nested binary tree can be encoded in a computer-readable medium or a computer, when loaded into a computer or similar hardware, makes the computer perform this invention.

### BRIEF DESCRIPTION OF THE DRAWINGS

FIG. 1 illustrates the star schema for the network data stream.

FIG. 2 illustrates the network data stream star schema.

FIG. 3 illustrates the flowchart of the insert operation.

FIG. 4 illustrates the flowchart add_record_to_tree.

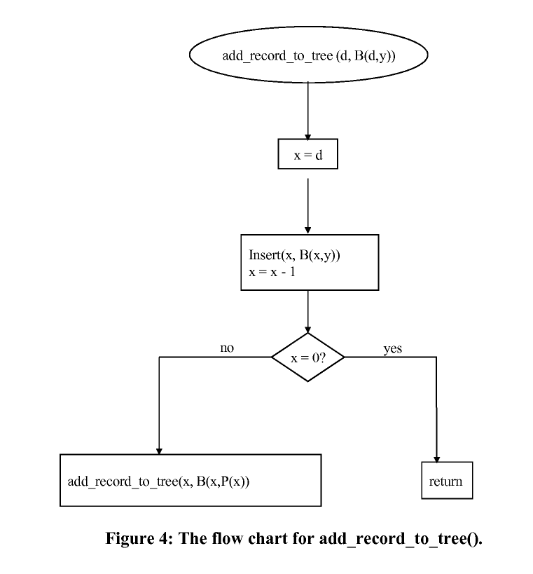

### DETAIL DESCRIPTIONS OF THE INVENTION

There are three kinds of OLAP data cube implementation. In Relational OLAP (ROLAP) a dynamic relational database is used as the data implementation. This typically is a star schema. In Multi-dimensional OLAP (MOLAP) a multi-dimensional data cube is used as the data implementation. In Hybrid OLAP (HOLAP) a combination of ROLAP and MOLAP is used. In some systems, a relational database is used to store data values and a data cube is used to store data aggregates which may take more space than necessary.

Streaming OLAP exacerbates the data cube materialization problem since data stream rates can be high. A number of authors have concentrated on filtering streams into data cubes. This approach is restrictive. A better method is to input the entire data stream into the data cube. This approach preserves all data for analysis but may not keep up with data cube construction for the incoming data rate.

The MOLAP data cube was originally implemented as a multi-dimensional array. Most advanced OLAP applications implement the data cube as a tree forest. Each dimensional attribute is represented as a separate and distinct tree. That is each tree node points to a tree at the next dimension. In addition, all OLAP implementations are strictly limited to data aggregates.

In this invention, a new database structure is proposed to handle high speed data streams. In the proposed database, instead of multiple string tables as in previous work, a single global table is used to store all data strings. Also, instead of inserting strings into a sorted string table, which takes O(log nₜ) time for each table insertion where nₜ is the table size, strings are appended to the global string table, which takes constant time, to accommodate the high data stream rate. Multiple copies of strings are allowed in the global string table. Another advantage is that database records are of constant size because the records contain indices into the global string table instead of variable length strings. This makes construction of the data cube easier. In addition, a new type of data cube is proposed to handle aggregate queries with d parameters. The data cube is a nested binary tree with d levels. In a binary tree at the lowest level, each node corresponds to a combination of attributes and a list of records that use that combination. The number of nodes in the lowest level binary trees is the number of combinations that are used by at least one record. In other words, only combinations with at least one record are included. In a binary tree at higher levels, a node is another binary tree. The construction of this nested binary tree takes

$$O ( n {\sum }_{i = 1}^{d} log {a}_{i} )$$

time where n is the number of records in the database and aᵢ is the number of attributes for dimension i.

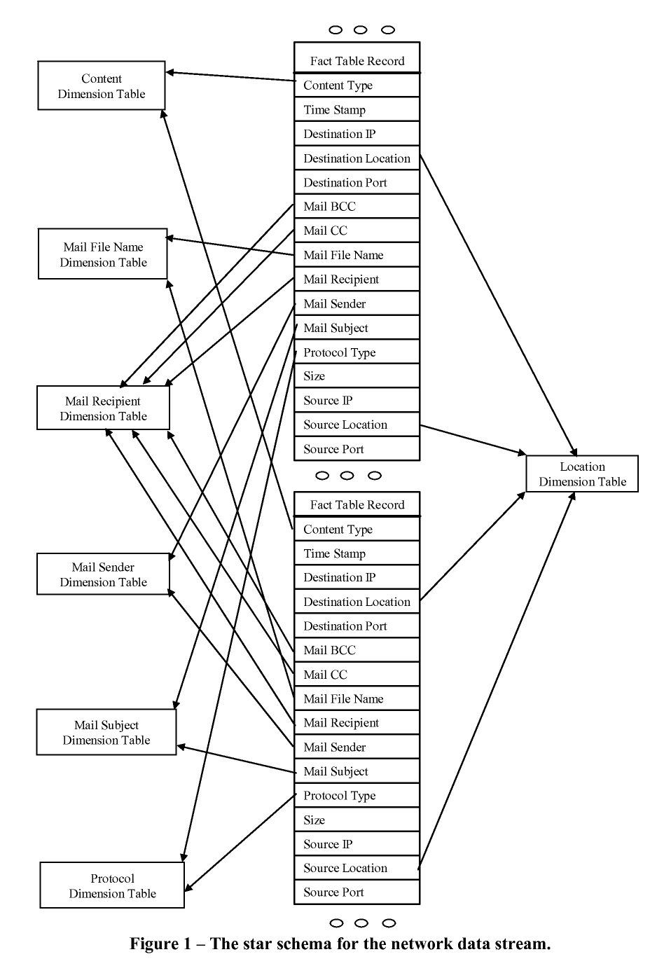

A record in the network data stream database consists of the 16 tuple: (content type, time stamp, destination ip, destination location, destination port, mail bcc, mail cc, mail file name, mail recipient, mail sender, mail subject, protocol type, size, source ip, source location, source port) as shown in FIG. 1. Each tuple is referred as a dimension or field.

The star schema for the network data stream contains a single fact table and 7 global dimension tables. Two fact table records are shown. A fact table record has 16 dimensions. Numerical fields hold data values and string fields contain indexes into dimension tables. All strings are stored in the dimension tables. In general, dimension tables are sorted and do not contain duplicate strings.

A star schema is a dynamic database that is structured to minimize disk space [27, 28]. A star schema consists of fact tables and dimension tables. Fact tables contain millions of records. Each record has multiple fields or dimensions. Data in some dimensions are of fixed size. Such a dimension is called a numerical dimension. Data in other dimensions are of variable size and such dimensions are called string dimensions. A dimension table is created for one or more string dimensions to eliminate string duplication. In a fact table record, numerical dimensions contain data and string dimensions contain indices into the corresponding dimension tables. The star schema for the network data stream is presented in FIG. 1. The dimension “time stamp” is a numerical dimension and the dimension “mail subject” is a string dimension. This star schema contains a single fact table and seven dimension tables. Each record in the fact table has 16 fields. Numerical fields (time stamp, destination ip, destination port, size, source ip, source port) hold numerical values directly in the fact table since they are of fixed size. String dimensions (content, destination location, mail bcc, mail cc, mail file name, mail recipient, mail sender, mail subject, protocol, source location) hold indices pointing into dimension tables where variable length strings are stored. In general, dimension tables are sorted and do not contain duplicate strings.

For a streaming database, data records come in at a high rate. Suppose there are k dimension tables and table i has nₜᵢ items. Then it takes

$$O ( {\sum }_{i = 1}^{k} ( log {n}_{ti} )$$

time to insert a single data record into the database. For some dimension tables, such as the mail subject dimension table in FIG. 1, the table size nₜᵢ can be large. One problem with the star schema is that insertion operations cannot keep up with the input rate. Also there is no need to sort all of the items in the dimension tables if duplication is allowed. Later it becomes clear that unsorted dimension tables and allowing multiple copies of a data item does not increase data cube construction time, although it does take more space because dimensions with duplicates are unlikely to be used as a parameter in a aggregate query. A new type of star schema, named the stream star schema, is proposed to accommodate the high data input rate and is described below.

A stream star schema is a dynamic database with fact tables, a global string table, and a limited number of dimension tables. Like the star schema, fact tables contain millions of records. Each record has multiple fields. Numerical dimensions hold fixed sized data values in a record. Unlike the star schema, all input strings are stored in a global string table. String dimensions hold indices into either a dimension table or the global string table. Also dimension tables contain indices into the global string table. When data come in, all strings are appended to the string table and the indices are inserted into fact tables and dimension tables. A stream star schema is formally defined as D(S,R,T,G), where S is a set of fact tables, R is a set of dimensions, T is a set of dimension tables, and G is the global string table.

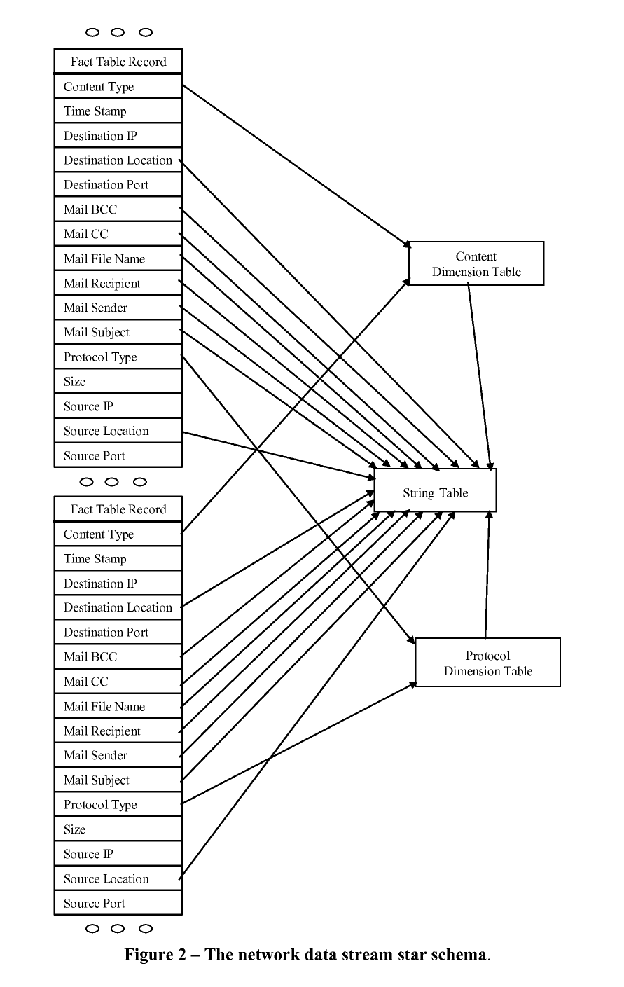

For example: the stream star schema for the network data stream, shown in FIG. 2, contains a single fact table, a global string table, and two dimension tables for dimensions “content” and “protocol”. Each record has 16 fields. Numerical fields (time stamp, destination ip, destination port, size, source ip, source port) hold fixed sized numerical values. Other fields, except “content” and “protocol”, contain indices into the global string table. The “content” and “protocol” fields contain indices into the two dimension tables and the two dimension tables contain indices into the global string table. Formally the stream star schema for the network data stream is defined as D(S,R,T,G), where S={fact table}, R={content, time stamp, destination ip, destination location, destination port, mail bcc, mail cc, mail file name, mail recipient, mail sender, mail subject, protocol, size, source ip, source location, source port}, T={content dimension table, protocol dimension table}, and G is the global string table.

Two fact table records are shown. Each fact table record has 16 fields. There is one fact table, two dimension tables, and one string table. For example: the content field holds an index to the content dimension table that holds an index to the string table. All strings are stored in the global string table.

In the proposed stream star schema, some string dimensions have their own dimension tables, such as “protocol” and “content” (FIG. 2) in the example and all others share the global string table. Separate dimension tables are created only for string dimensions that are reliably bounded and where duplication is significant. For example: for the protocol dimension, there are 59 possible protocols and many records use the same protocol. If the protocol dimension uses the global string table, much duplication is expected. In other words one million records would have one million protocols with only 59 different values. A separate dimension table is thus created for this dimension. Because the protocol dimension table size is 59, the insertion operation will not be a problem. There are 201 possible content attributes for the “content” dimension and a separate dimension table is also created for the same reason. On the other hand, the “mail subject” dimension is not bounded and duplication is not likely. For one million records it is quite possible that all “mail subject” strings are unique. That is why this dimension uses the global string table.

The proposed stream star schema has two main differences from a star schema. The first difference is that all strings are stored in a global string table, so that fact tables only contain fixed sized values: fixed size data or indices. Hence all fact table records have the same size. The second difference is data insertion. In the star schema, strings of one record are inserted into different sorted dimension tables. That operation takes

$$O ( {\sum }_{i = 1}^{k} ( log {n}_{ti} )$$

time with possibly large nₜᵢ as previously mentioned. In a stream star schema, all incoming strings are appended to the global string table that is unsorted. This minimizes the insertion time to a constant. Our experiments show that the star schema for the network data stream can insert a maximum of 500,000 records per hour. The stream star schema for the network data stream can insert a minimum of 70,000,000 records per hour. Thus for the network data stream, the stream star schema is 140 times faster than the star schema for database insertions. Clearly the disadvantage of the stream star schema is that the string table may become huge.

A star schema focuses on minimizing disk space. Dimension tables are sorted without duplication. The down side is that insertion time for a single record is

$$O ( {\sum }_{i = 1}^{k} ( log {n}_{ti} )$$

and becomes unacceptable when the database size becomes large and the data rate is high. The stream star schema is proposed to keep up with the incoming data stream rate. The focus is thus not on minimizing disk space but rather on minimizing insertion time. There is a tradeoff between disk space and insertion time. In the stream star schema, more dimension tables can be created as long as the system can keep up with the input data stream rate. The fastest system is the one without any dimension tables. Table 1 summarizes the advantages and disadvantages of the stream star schema and the star schema.

TABLE 1
Comparison of the stream star schema and the star schema.

| Stream Star Schema | Star Schema |
|---|---|
| Three kinds of tables—fact, dimension, | Two kinds of tables—fact, |
| string. | dimension. |
| Few dimension tables. | All string dimensions have |
| | dimension tables. |
| Minimize insertion time. | Minimize disk space. |
| Dimension tables are small. | Dimension tables can be large. |
| Insert time = constant. | $Insert time = O ( {\sum }_{i = 1}^{k} ( log {n}_{ti} ) ) .$ |
| Allow string duplication. | Do not allow string duplication. |

An instance of the network data stream is used to illustrate the basic ideas in this section and is shown in Example 1. In this instance, there are two chunks of records. Five out of 16 fields are shown in each record for the purpose of this section. The two dimension tables: content table and protocol table are in Example 2. The global string table is in Example 3. In each record in Example 1, the first field is the address or ID. The second field is the index into the content dimension table. The third field is the index into the protocol dimension table. The fourth field is the numeric time stamp value. The fifth field is the numeric source IP value. The last field is the numeric destination IP value. For example: record 3 in chunk 1 uses content “BMP” and protocol “AOL” because its content field points to item 1 in the content dimension table which points to item 18 in the global string table and its protocol field points to item 0 in the protocol dimension table which points to item 3 in the global string table.

Data cubes are created to pre-calculate GROUP BY queries. Consider the GROUP BY query (protocol, content) as applied to the database in the Example. The aggregate of this query is how many records in fact table chunks 1 and 2 use a particular protocol and content. The value of this query is the fact table record values (protocol, content, time stamp, source ip, destination ip). An instance of the query is (AOL, JPEG) which asks how many records use protocol “AOL” and content “JPEG”. The value of this query is all the records that use protocol “AOL” and content “JPEG”. Since the GROUP BY query has two dimensions, the resulting data cube has two dimensions. Each data cube cell is indexed by protocol and content. Thus if one wants to know how many records have protocol “Skype” and content “GIFF”, the answer is in data_cube[Skype][GIFF] or data_cube[5][8]. Looking up the answer in the data cube is obviously much faster than calculating the answer at the real time.

One disadvantage of MOLAP data cubes is that the data cube only stores data aggregates. A MOLAP data cube cannot be used to provide GROUP BY query values. For example: Example 9 contains the value query that corresponds to the aggregate query in Example 8. The value query allows the user to view all fact record data, not just protocol and content. Another disadvantage of MOLAP data cubes is that high incoming data stream rates (gigabits per second) severely limit time available for data cube construction. Since the input to a data cube is a database, data cube construction must keep up with database growth. A streaming database with a high input rate forces data cube construction to be fast.

Currently, most efficient MOLAP implementations [7, 8, 10, 26] use data cube forests. Data cube forests consist of nested trees. The construction time is about

$$O ( {\sum }_{i = 1}^{d} log {a}_{i} )$$

per node, where aᵢ is the number of data items in the tree at level i and d is the number of dimensions. A data cube forest consists of multiple levels of trees, not necessarily binary. Each level or branch represents a dimension in the data cube and corresponds to a dimension in the GROUP BY query. Interior nodes of the tree can also contain data aggregates.

The stream data cube is implemented as a nested binary tree. The time complexity of constructing the nested binary tree is about the same as MOLAP data cube forests construction. Only leaf nodes contain data aggregates. Leaf nodes also point to a linked list of records with identical attribute values. Thus leaf nodes contain data aggregates and point to data values. To achieve this performance, fact table records must be of fixed size so that fact table indexing is trivial. This is the primary reason why fact tables do not contain strings but rather indexes into the string table. The nested binary tree is defined formally in the following.

Definition: a level 1 nested binary tree is an ordinary binary tree and a level d nested binary tree is a binary tree, where each node is a level d−1 nested binary tree. A nested binary tree is denoted as B(x,y) where x denotes the level of the binary tree and y indexes all binary trees at the same level. Each node in a level d binary tree has an additional field pointing to the root of the next level binary tree. Each node in a level 1 binary tree has two additional fields: one holds the aggregate count and the other holds a linked list of records with identical attribute values.

The example in Example 1 is used to illustrate how a nested binary tree is constructed to answer the query GROUP BY (protocol, content). Since there are two parameters in the query, a level 2 nested binary tree is constructed. The most significant level is “protocol” and the least significant level is “content”. The nested binary trees constructed by the procedure create_stream_cube( ) (which will be presented later) are in appendices 4 and 5. There is a global table denoted as BBT that lists all binary trees and is shown in Example 6. There is one level 2 binary tree denoted as B(2, 0) as shown in Example 4. There are ten nodes in B(2, 0) each of which corresponds to a protocol and points to a content binary tree. There are ten level 1 binary trees denoted as B(1, 0), . . . , B(1, 9) as shown in Example 5. If a binary tree node is another binary tree, then the node contains a field pointing to the root of next level binary tree. For example: node “AOL” in B(2, 0) contains a field pointing to binary tree B(1, 7). A node of a level 1 binary tree contains the aggregate count and a list of records that all use the same protocol and content. For example, node “Basic Source” in B(1, 0) contains the aggregate value 3 and a list of records: record 0 in chunk 1, record 1 in chunk 1, and record 2 in chunk 1. The three records are the only ones that use protocol “AOL” and content “Basic Source”.

Before the procedure of constructing the nested binary tree is presented, some definitions and operations are needed. BTT is a global table listing all binary trees with their addresses. Pointers p(j), j=1, . . . , d−1 are used in the procedure to help create the index of the trees at level j. Besides the normal fields of a traditional binary tree, the following fields are added. The first added field is attribute that holds the attribute value of the corresponding node. For example: the attribute field in the root node in the binary tree in Example 4 holds “SMB”. For binary trees that are not at the first level, the second added field holds a pointer to the next level binary tree. For example: the root node in the binary tree in Example 4 points to binary tree B(1, 0) at the first level. For the trees at the first level, the seconded added field is aggregate that holds the number of records using the combination of attributes corresponding to that node. The third added field for trees at the first level is value that contains a list of indexes of records that use that combination of attributes.

Two operations are defined. The first operation is to create a binary tree at level x with index y (the y^{th} binary tree at level x). Also, this operation adds the address of the root of the created binary tree to the BBT. The operation is formally defined below.

Procedure create_tree(x,y).
Input: x - binary tree level.
Input: y - index into BTT.
Output: B(x,y) - new binary tree with uninitialized fields.
Step 1. Create a new binary tree with level x and index y.
Step 2. Add the address of the root node to BTT.

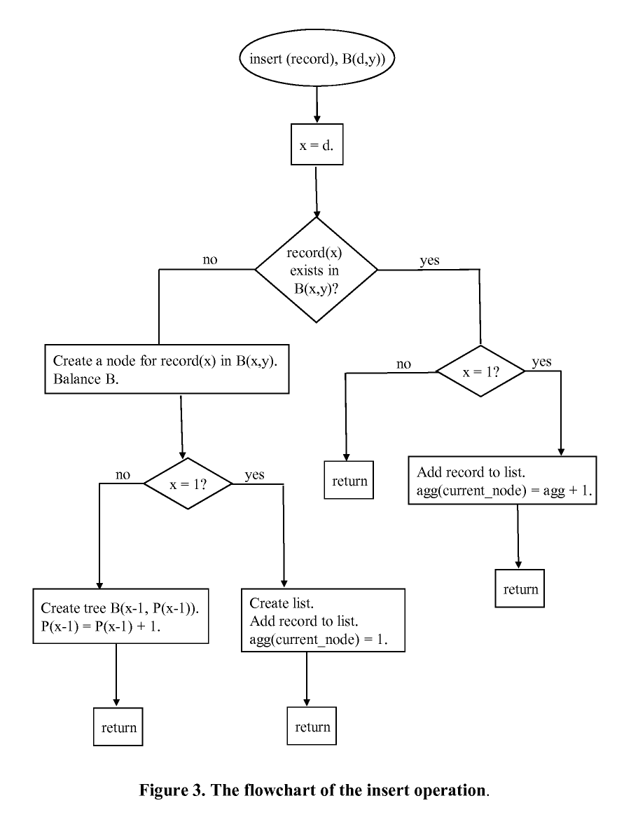

The second operation is the insert operation and is described in the flow chart in FIG. 3. This operation tries to insert a given key into a given binary tree. The basic idea of this operation is as follows: given a key in the d^{th} dimension record(d) and a binary tree B(d,y) with d>1, if the key exists in the given tree B(d,y), then do nothing. If it does not exist, then create a node and a binary tree for this key and rebalance the binary tree. If the given binary tree is at the first level, the aggregate and value fields are either created or updated. It is assumed that there is a global buffer holding the record being processed. Notation record(i) denotes the i^{th} key of the current record. For example, when the record with ID 2 in chunk 2 in Example 1 is processed, record(2)=SSH and record(1)=Basic Source.

The following is the procedure to create a nested binary tree. Each record is processed once.

```
Procedure create_nested_binary_tree(D,Q).
  Input: D(S,R,T) - stream star schema.
  Input: Q(L,d) - GROUP BY query.
Output: B(d,0) - nested binary tree with d levels.
Step 1. P(j)=0, j=d, ..., 1.
Step 2. Create B(d,0).
Step 3. For each stream star schema chunk in C do:
Step 4. For each fact table record in chunk do:
Step 5. add_record_to_tree(d, B(d,0));
```

The subroutine add_record_to_tree( ) properly adds the current key to the corresponding binary tree. This subroutine is described by the following flowchart. As shown by the flowchart, this subroutine is recursive.

The complexity of the above algorithm is derived as follows. Let n be the number of records in the database, aᵢ is the number of attributes in dimension i, and d is the number of dimensions of the query. Let b_{i,y} be the number of nodes in binary tree B(i,y). Clearly, b_{i,y}≦aᵢ. Then it takes O(log b_{i,y}) time to insert a key in tree B(i,y) and

$$O ( {\sum }_{i = 1}^{d} ( log {b}_{i , {y}_{i}} ) \leq O ( {\sum }_{i = 1}^{d} ( log {a}_{i} )$$

time to insert a record into the nested binary trees. Therefore the complexity of construct of the entire nested binary tree is

$$O ( n {\sum }_{i = 1}^{d} ( log {a}_{i} ) .$$

After the nested binary tree is constructed, all possible meaningful aggregate and value queries can by listed alphabetically by a depth first search of the binary tree. In Example 7, all records are listed according to the depth first search. The aggregate and value query for the example in Example 1 are shown in Example 8 and 9 respectively.

There are two main differences between stream data cubes and MOLAP data cubes. First, MOLAP data cubes only provide answers to aggregate queries. Stream data cubes can answer value and aggregate queries. Second, stream data cube construction is at least as fast as MOLAP data cube construction. MOLAP and stream data cube construction are both of time complexity

This data cube supports both data aggregates and data values. The time complexity of constructing such a nested tree is

$$O ( n {\sum }_{i = 1}^{d} log {a}_{i} )$$

where n is the number of database records, aᵢ is the number of attributes in dimension i, and d is the number of levels in the nested binary tree.

The disclosed invention of the new structure of stream star schema and the new data cube type of nested binary tree can be encoded in a computer-readable medium or a computer, when loaded into a computer or similar hardware, makes the computer perform this invention.

Although illustrative embodiments have been described herein with reference to the accompanying drawings is exemplary of a preferred present invention, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

### Example 1

### An Instance of the Network Stream Star Schema

Only five fields are shown. The other 11 fields are omitted to save space. There are two fact table chunks. The “content” field contains the index into the content dimension table in Example 2. The “protocol” field contains the index into the protocol dimension table in Example 2. For example: record 1 in chunk 1 uses content “Basic Source” and protocol “AOL”.

Flow Fact Table Chunk 1

| ID | Content | Protocol | Date Stamp | Source IP | Destination IP |
|---|---|---|---|---|---|
| 0 | 0 | 0 | 1166832000 | 1386674766 | 2033605883 |
| 1 | 0 | 0 | 1166832001 | 1400042563 | 1386674766 |
| 2 | 0 | 0 | 1166832002 | 1386674766 | 4171782323 |
| 3 | 1 | 0 | 1166832005 | 2033605883 | 1386674766 |
| 4 | 2 | 0 | 1166832006 | 2033605883 | 1386674766 |
| 5 | 3 | 1 | 1166832007 | 1386674766 | 1400034383 |
| 6 | 4 | 2 | 1166832008 | 2033605883 | 1400042563 |
| 7 | 5 | 3 | 1166832010 | 4171782323 | 1400034383 |
| 8 | 5 | 3 | 1166832011 | 1386674766 | 1366206374 |
| 9 | 6 | 4 | 1166832012 | 1400034383 | 1386674766 |
| 10 | 7 | 4 | 1166832013 | 1400042563 | 1366206374 |
| 11 | 8 | 5 | 1166832014 | 4171782323 | 1366206374 |
| 12 | 8 | 5 | 1166832015 | 4171782323 | 1400042563 |
| 13 | 9 | 6 | 1166832020 | 1400034383 | 1366206374 |
| 14 | 10 | 7 | 1166832021 | 1366206374 | 1386674766 |
| 15 | 11 | 8 | 1166832022 | 1400042563 | 2033605883 |

Flow Fact Table Chunk 2

| ID | Content | Protocol | Date Stamp | Source IP | Destination IP |
|---|---|---|---|---|---|
| 0 | 11 | 8 | 1166832030 | 1386674760 | 2033605883 |
| 1 | 11 | 8 | 1166832031 | 1400042561 | 1386674766 |
| 2 | 0 | 8 | 1166832032 | 1386674762 | 4171782323 |
| 3 | 1 | 8 | 1166832033 | 2033605881 | 1386674766 |
| 4 | 1 | 8 | 1166832040 | 1386674764 | 4171782323 |
| 5 | 1 | 8 | 1166832041 | 1386674766 | 1400034383 |
| 6 | 1 | 8 | 1166832042 | 2033605883 | 1400042563 |
| 7 | 2 | 8 | 1166832043 | 4171782323 | 1400034383 |
| 8 | 2 | 8 | 1166832044 | 1386674766 | 1366206374 |
| 9 | 2 | 8 | 1166832045 | 1400034383 | 1386674766 |
| 10 | 10 | 8 | 1166832046 | 1400042563 | 1366206374 |
| 11 | 10 | 8 | 1166832047 | 4171782323 | 1366206374 |
| 12 | 10 | 8 | 1166832048 | 4171782323 | 1400042563 |
| 13 | 9 | 9 | 1166832049 | 1400034383 | 1366206374 |
| 14 | 9 | 9 | 1166832050 | 1366206374 | 1386674766 |

### Example 2

### The Dimension Tables in Example 1

The two dimension tables for the example in Example 1. Note that the Content Dimension Table and Protocol Dimension Table are both sorted. The String Table ID is the index into the Global String Table shown in Example 3.

Content
Dimension Table

| ID | String Table ID |
|---|---|
| 0 | 19 |
| 1 | 18 |
| 2 | 20 |
| 3 | 15 |
| 4 | 7 |
| 5 | 21 |
| 6 | 5 |
| 7 | 16 |
| 8 | 8 |
| 9 | 4 |
| 10 | 17 |
| | . . . |
| 200 | |

Protocol
Dimension Table

| ID | String Table ID |
|---|---|
| 0 | 3 |
| 1 | 12 |
| 2 | 11 |
| 3 | 1 |
| 4 | 9 |
| 5 | 14 |
| 6 | 0 |
| 7 | 10 |
| 8 | 2 |
| 9 | 13 |
| | . . . |
| 58 | |

### Example 3

### The Global String Table in Example 1

The global string table is not sorted and contains duplicate strings.

Global String Table

| ID | String |
|---|---|
| 0 | SMB |
| 1 | LDAP |
| 2 | SSH |
| 3 | AOL |
| 4 | JPEG |
| 5 | English |
| 6 | ZIP |
| 7 | Compress |
| 8 | GIFF |
| 9 | POP |
| 10 | SMTP |
| 11 | IMAP |
| 12 | FTP |
| 13 | Telnet |
| 14 | Skype |
| 15 | CMS |
| 16 | French |
| 17 | Russian |
| 18 | BMP |
| 19 | Basic Source |
| 20 | C Source |
| 21 | Discover |
| 22 | today's meeting |
| 23 | 49′ers draft picks |
| 24 | stock price |
| 25 | the meaning of life |
| 26 | Christmas |
| 27 | Steve |
| 28 | Tom |
| 29 | Mary |
| 30 | Mary |
| 31 | Christmas |
| 32 | dog |
| 33 | dog |
| 34 | cow |

### Example 4

### The Level 2 Binary Tree in Example 1

Given the fact table in Example 1, the query (protocol, content) results in a single protocol binary tree: B(2, 0). Each tree node points to a level 1 content binary tree.

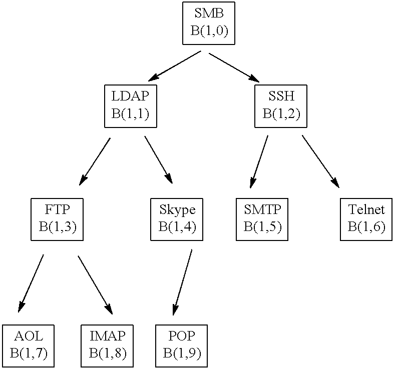

### Example 5

### The Level 1 Binary Trees in Example 1

Given the fact table in Example 1, the query (protocol, content) results in multiple content binary trees: B(1, 0) . . . B(1, 9). Each tree node contains a content type, an aggregate count, and a list of fact table records. A fact table record is the 2-tuple (chunk, record). For example: the tree node for B(1, 1) indicates that there is 1 fact table record (chunk 1, record 5) for protocol “FTP” and content “CMS”.

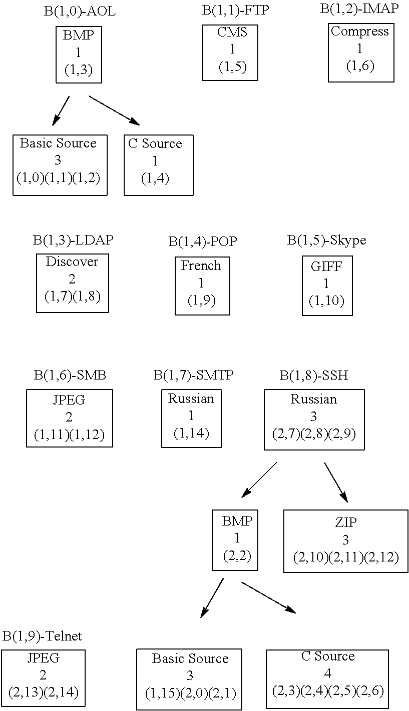

### Example 6

### The Global Table BTT in Example 1

The following table contains the list of all the binary trees constructed during the execution create_stream_cube( ) for the example in Example 1.

Binary Trees

| Name | Type |
|---|---|
| B(1,0) | SMB |
| B1,1) | LDAP |
| B(1,2) | SSH |
| B(1,4) | Skype |
| B(1,5) | SMTP |
| B(1,6) | Telnet |
| B(1,7) | AOL |
| B(1,8) | IMAP |
| B(1,9) | POP |

### Example 7

### The Depth First Search in Example 1

Given the fact table in Example 1, the query (protocol, content) is created by a depth first search on the stream data cube.

Depth First Search

| Protocol | Content | Fact Table Chunk | Fact Table Record |
|---|---|---|---|
| AOL | Basic Source | 1 | 0 |
| AOL | Basic Source | 1 | 1 |
| AOL | Basic Source | 1 | 2 |
| AOL | BMP | 1 | 3 |
| AOL | C Source | 1 | 4 |
| FTP | CMS | 1 | 5 |
| IMAP | Compress | 1 | 6 |
| LDAP | Discover | 1 | 7 |
| LDAP | Discover | 1 | 8 |
| POP | English | 1 | 9 |
| POP | French | 1 | 10 |
| Skype | GIFF | 1 | 11 |
| Skype | GIFF | 1 | 12 |
| SMB | JPEG | 1 | 13 |
| SMTP | Russian | 1 | 14 |
| SSH | Basic Source | 2 | 2 |
| SSH | BMP | 2 | 3 |
| SSH | BMP | 2 | 4 |
| SSH | BMP | 2 | 5 |
| SSH | BMP | 2 | 6 |
| SSH | C Source | 2 | 7 |
| SSH | C Source | 2 | 8 |
| SSH | C Source | 2 | 9 |
| SSH | Russian | 2 | 10 |
| SSH | Russian | 2 | 11 |
| SSH | Russian | 2 | 12 |
| SSH | ZIP | 1 | 15 |
| SSH | ZIP | 2 | 0 |
| SSH | ZIP | 2 | 1 |
| Telnet | JPEG | 2 | 13 |
| Telnet | JPEG | 2 | 14 |

### Example 8

### The Aggregate Query in Example 1

Given the fact table in Example 1, the following is the result of the aggregate query (protocol, content).

Aggregate Query

| Protocol | Content | Records |
|---|---|---|
| AOL | Basic Source | 3 |
| AOL | BMP | 1 |
| AOL | C Source | 1 |
| FTP | CMS | 1 |
| IMAP | Compress | 1 |
| LDAP | Discover | 2 |
| POP | English | 1 |
| POP | French | 1 |
| Skype | GIFF | 2 |
| SMB | JPEG | 1 |
| SMTP | Russian | 1 |
| SSH | Basic Source | 1 |
| SSH | BMP | 4 |
| SSH | C Source | 3 |
| SSH | Russian | 3 |
| SSH | ZIP | 3 |
| Telnet | JPEG | 2 |

### Example 9

### The Value Query in Example 1

Given the fact table in Example 1, the following is the result of the value query (protocol, content).

Value Query

| Protocol | Content | Date Stamp | Source IP | Destination IP |
|---|---|---|---|---|
| AOL | Basic Source | 1166832000 | 1386674766 | 2033605883 |
| AOL | Basic Source | 1166832001 | 1400042563 | 1386674766 |
| AOL | Basic Source | 1166832002 | 1386674766 | 4171782323 |
| AOL | BMP | 1166832005 | 2033605883 | 1386674766 |
| AOL | C Source | 1166832006 | 2033605883 | 1386674766 |
| FTP | CMS | 1166832007 | 1386674766 | 1400034383 |
| IMAP | Compress | 1166832008 | 2033605883 | 1400042563 |
| LDAP | Discover | 1166832010 | 4171782323 | 1400034383 |
| LDAP | Discover | 1166832011 | 1386674766 | 1366206374 |
| POP | English | 1166832012 | 1400034383 | 1386674766 |
| POP | French | 1166832013 | 1400042563 | 1366206374 |
| Skype | GIFF | 1166832014 | 4171782323 | 1366206374 |
| Skype | GIFF | 1166832015 | 4171782323 | 1400042563 |
| SMB | JPEG | 1166832020 | 1400034383 | 1366206374 |
| SMTP | Russian | 1166832021 | 1366206374 | 1386674766 |
| SSH | Basic Source | 1166832032 | 1386674762 | 4171782323 |
| SSH | BMP | 1166832033 | 2033605881 | 1386674766 |
| SSH | BMP | 1166832040 | 1386674764 | 4171782323 |
| SSH | BMP | 1166832041 | 1386674766 | 1400034383 |
| SSH | BMP | 1166832042 | 2033605883 | 1400042563 |
| SSH | C Source | 1166832043 | 4171782323 | 1400034383 |
| SSH | C Source | 1166832044 | 1386674766 | 1366206374 |
| SSH | C Source | 1166832045 | 1400034383 | 1386674766 |
| SSH | Russian | 1166832046 | 1400042563 | 1366206374 |
| SSH | Russian | 1166832047 | 4171782323 | 1366206374 |
| SSH | Russian | 1166832048 | 4171782323 | 1400042563 |
| SSH | ZIP | 1166832022 | 1400042563 | 2033605883 |
| SSH | ZIP | 1166832030 | 1386674760 | 2033605883 |
| SSH | ZIP | 1166832031 | 1400042561 | 1386674766 |
| Telnet | JPEG | 1166832049 | 1400034383 | 1366206374 |
| Telnet | JPEG | 1166832050 | 1366206374 | 1386674766 |

1. A computer-implemented method for applying Online analytical processing (OLAP) database to streaming data, comprising steps of:
setting up a dynamic database of stream star schema comprising
a plurality of fact tables;
a global string table; and
a plurality of dimension tables;
storing all input data strings to the global string table; and
inserting the indices into fact tables and dimension tables.

2. The computer-implemented method for applying OLAP database to streaming data according to claim 1, wherein the fact table comprises a plurality of records.

3. The computer-implemented method for applying OLAP database to streaming data according to claim 2, wherein the records comprises a plurality of fields.

4. The computer-implemented method for applying OLAP database to streaming data according to claim 3, wherein the plurality of dimension tables contain indices into the global string table.

5. The computer-implemented method for applying OLAP database to streaming data according to claim 4, wherein the fact tables only contain fixed sized data or indices and the fact table records have the same size.

6. The computer-implemented method for applying OLAP database to streaming data according to claim 5, wherein all incoming strings are appended to the global string table unsorted.

7. The computer-implemented method for applying OLAP database to streaming data according to claim 6, further comprising steps of:
implementing a stream data cube as a nested binary tree;
creating a binary tree at a level with a index;
adding the address of the root of the created binary tree; and
inserting a record into the created binary tree.

8. The computer-implemented method for applying OLAP database to streaming data according to claim 7, wherein for binary trees that are not at the first level, the second added field holds a pointer to the next level binary tree and for the trees at the first level, a seconded added field is aggregate that holds the number of records using a combination of attributes corresponding to that node.

9. The computer-implemented method for applying OLAP database to streaming data according to claim 8, wherein a third added field for trees at the first level is value that contains a list of indexes of records that use a combination of attributes.

10. The computer-implemented method for applying OLAP database to streaming data according to claim 9, wherein the step of inserting a record into the created binary tree further comprising creating a node for a record in the created binary tree if the record does not exist in the created binary tree, otherwise adding a record to a list to the created binary tree.

11. A computer-implemented method for applying Online analytical processing (OLAP) database to streaming data, comprising steps of:
implementing a stream data cube as a nested binary tree;
creating a binary tree at a level with a index;
adding the address of the root of the created binary tree; and
inserting a record into the created binary tree.

12. The computer-implemented method for applying OLAP database to streaming data according to claim 11, wherein for binary trees that are not at the first level, the second added field holds a pointer to the next level binary tree and for the trees at the first level, a seconded added field is aggregate that holds the number of records using a combination of attributes corresponding to that node.

13. The computer-implemented method for applying OLAP database to streaming data according to claim 12, wherein a third added field for trees at the first level is value that contains a list of indexes of records that use a combination of attributes.

14. The computer-implemented method for applying OLAP database to streaming data according to claim 13, wherein the step of inserting a record into the created binary tree further comprising creating a node for a record in the created binary tree if the record does not exist in the created binary tree, otherwise adding a record to a list to the created binary tree.

15. The computer-implemented method for applying OLAP database to streaming data according to claim 14, further comprising steps of:
setting up a dynamic database of stream star schema comprising
a plurality of fact tables;
a global string table; and
a plurality of dimension tables;
storing all input data strings to the global string table; and
inserting the indices into fact tables and dimension tables.

16. The computer-implemented method for applying OLAP database to streaming data according to claim 15, wherein the fact table comprises a plurality of records.

17. The computer-implemented method for applying OLAP database to streaming data according to claim 16, wherein the records comprises a plurality of fields.

18. The computer-implemented method for applying OLAP database to streaming data according to claim 17, wherein the plurality of dimension tables contain indices into the global string table.

19. The computer-implemented method for applying OLAP database to streaming data according to claim 18, wherein the fact tables only contain fixed sized data or indices and the fact table records have the same size.

20. The computer-implemented method for applying OLAP database to streaming data according to claim 19, wherein all incoming strings are appended to the global string table unsorted.
